(19) United States
(12) Patent Application Publication
(10) Pub. No.: US 2026/0366266 A1
(43) Pub. Date: Nov. 19, 2026

(54) WORK MACHINE AND CONTROL METHOD FOR WORK MACHINE

(71) Applicant: KOMATSU LTD., Tokyo (JP)

(72) Inventor: Kazumichi OKAJIMA, Tokyo (JP)

(21) Appl. No.: 19/136,925

(22) PCT Filed: Dec. 18, 2023
(86) PCT No.: PCT/JP2023/045331

§ 371 Date: Jun. 9, 2025

(30) Foreign Application Priority Data
Jan. 19, 2023 (JP) 2023-006566

(51) Int. Cl. E02F 9/22; E02F 9/20

(52) U.S. Cl. CPC E02F 9/226; E02F 9/2066

(57) ABSTRACT

A work machine includes an engine, an operation unit configured to output a stop signal for the engine, a heat exchanger, a fan configured to cool the heat exchanger; and a controller configured to change rotation of the fan from forward rotation to reverse rotation during a period from when the stop signal is input to when the engine is stopped.

### CROSS-REFERENCE TO RELATED APPLICATIONS

This application is a U.S. National stage application of International Application No. PCT/JP2023/045331, filed on Dec. 18, 2023. This U.S. National stage application claims priority under 35 U.S.C. § 119(a) to Japanese Patent Application No. 2023-006566, filed in Japan on Jan. 19, 2023, the entire contents of which are hereby incorporated herein by reference.

### BACKGROUND

### Technical Field

The present invention relates to a work machine and a control method for a work machine.

### Background Information

A work machine such as a hydraulic excavator is provided with a heat exchanger unit including a plurality of heat exchangers for cooling various kinds of fluid (such as refrigerants), and a cooling fan for supplying cooling air to the heat exchanger unit. The heat exchanger unit includes, for example, a radiator through which cooling water for the engine passes, an oil cooler through which hydraulic oil for activating a hydraulic actuator passes, and an aftercooler through which compressed air passes (see, for example, JP 2020-84520 A).

Since a large amount of dust and the like are floating in the air at a work site where a work machine is operating, in the work machine described in JP 2020-84520 A, the dust and the like are carried to the heat exchanger unit by forward rotation of the cooling fan and adhere to the heat exchanger unit, and are then blown away by rotating the cooling fan in a reverse direction. Specifically, when a forward rotation activation time of the cooling fan has reached a first predetermined time, the cooling fan is rotated in the reverse direction for a second predetermined time. Further, even when the forward rotation operation time of the cooling fan has not yet reached the first predetermined time, the cooling fan is rotated in the reverse direction for the second predetermined time by operating a switch.

### SUMMARY

When high-load work is being performed while a vehicle is in operation, the temperatures of hydraulic oil and cooling water become high, making it impossible to perform the reverse rotation of the cooling fan, which reduces cooling efficiency, and thus cleaning of the heat exchanger may not be performed.

An object of the present disclosure is to provide a work machine capable of more reliably cleaning a heat exchanger and a control method for the work machine.

A work machine according to a first aspect of the present disclosure includes an engine, an operation unit, a heat exchanger, a fan, and a controller. The operation unit outputs a stop signal for the engine. The fan cools the heat exchanger. The controller changes rotation of the fan from forward rotation to reverse rotation during a period from when the stop signal is input to when the engine is stopped.

A control method for a work machine according to a second aspect of the present disclosure includes a stop signal input step and a rotation change step. In the stop signal input step, a stop signal for stopping an engine is input. In the rotation change step, rotation of a fan that cools a heat exchanger is changed from forward rotation to reverse rotation during a period from when the stop signal is input to when the engine is stopped.

According to the aspects of the present disclosure, it is possible to provide a work machine capable of more reliably cleaning a heat exchanger and a control method for the work machine.

### BRIEF DESCRIPTION OF DRAWINGS

FIG. 1 is a perspective view illustrating a hydraulic excavator according to an embodiment of the present disclosure.

FIG. 2 is a perspective view of the hydraulic excavator, viewed from the rear, according to the embodiment of the present disclosure.

FIG. 3 is a plan view illustrating a configuration inside an engine room of the hydraulic excavator according to the embodiment of the present disclosure.

FIG. 4 is a plan view illustrating a configuration inside an engine room of the hydraulic excavator according to the embodiment of the present disclosure.

FIG. 5 is a block diagram illustrating a configuration related to control of the hydraulic excavator according to the embodiment of the present disclosure.

FIG. 6 is a flowchart illustrating a control method for the hydraulic excavator according to the embodiment of the present disclosure.

FIG. 7 is a flowchart illustrating a control method for the hydraulic excavator according to the embodiment of the present disclosure.

FIG. 8 is a flowchart illustrating a control method for the hydraulic excavator according to the embodiment of the present disclosure.

### DETAILED DESCRIPTION OF EMBODIMENT(S)

A hydraulic excavator as an example of a work machine according to the present disclosure will be described below with reference to the drawings.

### Configuration

### Overview of Hydraulic Excavator 1

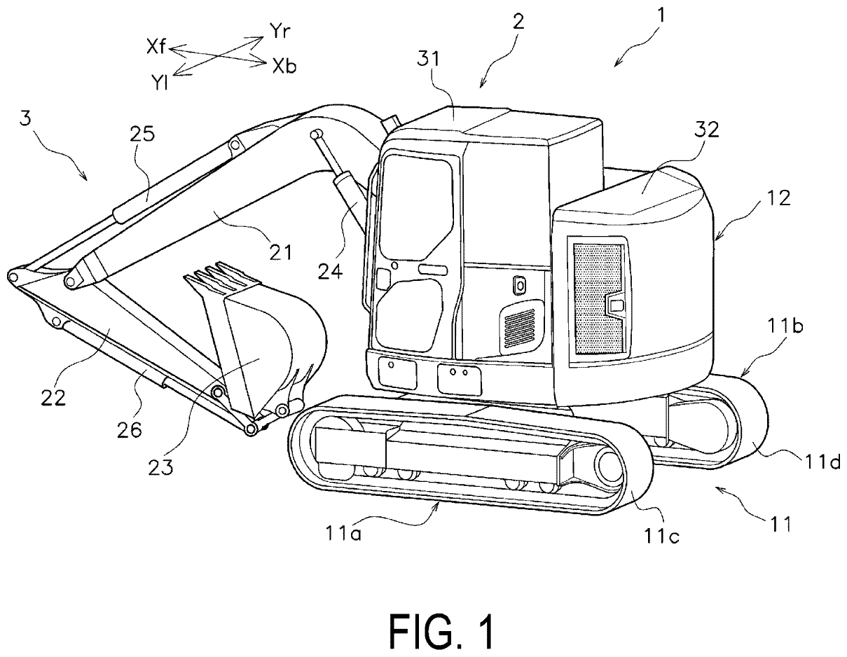

FIG. 1 is a schematic view illustrating a configuration of a hydraulic excavator 1 according to the present embodiment.

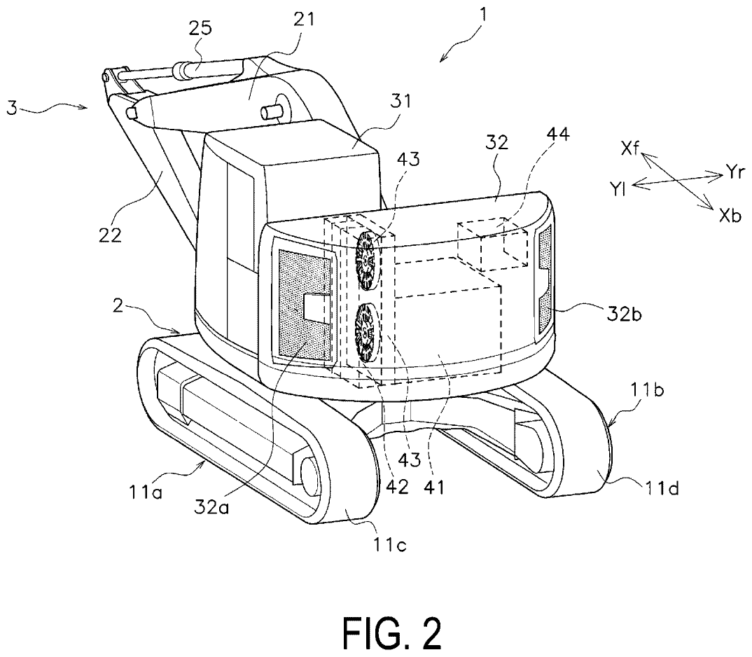

The hydraulic excavator 1 (an example of a work machine) includes a vehicle body 2 and a work implement 3. As illustrated in FIG. 1, the vehicle body 2 includes a traveling body 11 and a revolving body 12. The traveling body 11 includes a pair of traveling devices 11a and 11b. Each of the traveling devices 11a and 11b includes crawler belts 11c and 11d. A travel motor is rotated by a driving force from an engine 41 (see FIG. 2 described later), and the crawler belts 11c and 11d are driven to cause the hydraulic excavator 1 to travel.

The revolving body 12 is placed on the traveling body 11. The revolving body 12 is configured to be able to rotate relative to the traveling body 11 about an axis extending in the up-down direction by a revolving device (not illustrated). A cab 31 is provided at the front left side of the revolving body 12 as an operator seat where an operator sits during operation. An operator seat, levers for operating the work implement 3, various display devices, and the like are disposed inside the cab 31.

In the present embodiment, unless otherwise specified, front, rear, left and right will be described based on the operator seat in the cab 31. The direction in which the operator seat faces the front is defined as the forward direction (see an arrow Xf), and the direction opposite to the forward direction is defined as the rearward direction (see an arrow Xb). The right and left sides of the side direction when the operator seat is facing the front are defined as the right direction (see an arrow Yr) and the left direction (see an arrow Yl), respectively. In addition, in the present specification, the terms “height direction”, “vertical direction”, and “horizontal direction” refer to directions when the vehicle body 2 is in a horizontal state and not inclined, unless otherwise specified.

The work implement 3 is attached to the front center position of the revolving body 12. As illustrated in FIG. 1, the work implement 3 includes a boom 21, an arm 22, and an excavation bucket 23. The base end portion of the boom 21 is rotatably connected to the revolving body 12. In addition, the distal end portion of the boom 21 is rotatably connected to the base end portion of the arm 22. The distal end portion of the arm 22 is rotatably connected to the excavation bucket 23. The excavation bucket 23 is attached to the arm 22 so that an opening thereof can face the revolving body 12 (rearward). The hydraulic excavator 1 in which the excavation bucket 23 is attached in such a direction is called a backhoe.

Hydraulic cylinders 24 to 26 (a boom cylinder 24, an arm cylinder 25, and a bucket cylinder 26) are disposed so as to correspond to the boom 21, the arm 22, and the excavation bucket 23, respectively. The work implement 3 is driven by driving these hydraulic cylinders 24 to 26. This allows work such as excavation to be carried out.

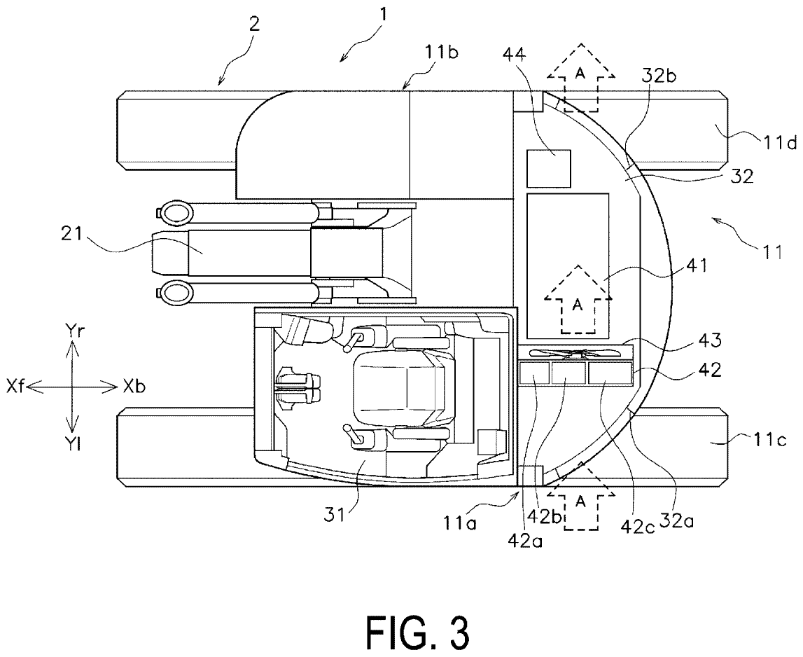

An engine room 32 is disposed behind the cab 31 of the revolving body 12. FIG. 2 is a perspective view schematically illustrating an internal configuration of the engine room 32. FIG. 3 is a schematic plan view of the hydraulic excavator 1 illustrating the internal configuration of the engine room 32. The revolving body 12 further includes the engine 41, a heat exchange unit 42, a plurality of fans 43, and a post-treatment device 44.

As illustrated in FIGS. 2 and 3, the engine room 32 houses the engine 41, the heat exchange unit 42, the plurality of fans 43, and the exhaust gas post-treatment device 44. The heat exchange unit 42, the plurality of fans 43, and the engine 41 are arranged side by side in this order from the left side to the right side.

The engine generates a driving force. The engine 41 is an internal combustion engine such as a diesel engine.

An air port 32a is disposed at the side wall of the engine room 32 on the left side of the heat exchange unit 42. A net is disposed at the air port 32a. An air port 32b is disposed at the side wall of the engine room 32 on the right side of the engine 41. A net is disposed at the air port 32b. When the fan 43 rotates in the forward direction, outside air is taken into the engine room 32 through the air port 32a, as indicated by an arrow A in FIG. 3. The air taken into the engine room 32 passes through the heat exchange unit 42 and the engine 41 in sequence, and is then discharged to the outside through the air port 32b.

### Heat Exchange Unit 42

As illustrated in FIG. 3, the heat exchange unit 42 includes an oil cooler 42a, an aftercooler 42b, and a radiator 42c. Each of the oil cooler 42a, the aftercooler 42b, and the radiator 42c is an example of a heat exchanger. The heat exchange unit 42 only needs to include at least one heat exchanger.

The oil cooler 42a is supplied with hydraulic oil for activating hydraulic actuators such as the hydraulic cylinders 24 to 26. The hydraulic oil is cooled as it passes through the oil cooler 42a. As illustrated in FIG. 3, the oil cooler 42a is disposed on the front side of the heat exchange unit 42.

The aftercooler 42b is supplied with compressed air obtained by taking in outside air and compressing it using a turbocharger (not illustrated). The aftercooler 42b is connected to the engine 41. The compressed air is cooled as it passes through the aftercooler 42b and is sent to the engine 41. The aftercooler 42b is disposed behind the oil cooler 42a.

Cooling water for the engine 41 is supplied to the radiator 42c. The supplied cooling water is cooled as it passes through the radiator 42c and is then discharged toward the engine 41. The cooling water for the engine is also supplied to the post-treatment device 44 (details of which will be described later) and also serves to cool the post-treatment device 44. In addition, the cooling water for the engine 41 is circulated and supplied by a water pump (not illustrated) that is operated by receiving a driving force from the engine 41. The radiator 42c is disposed behind the aftercooler 42b.

The oil cooler 42a, the aftercooler 42b, and the radiator 42c are arranged side by side in this order from the front side to the rear side of the hydraulic excavator 1.

### Fan 43

As illustrated in FIGS. 2 and 3, the plurality of fans 43 are disposed between the engine 41 and the heat exchange unit 42 in the left-right direction. The fan 43 is an electric fan.

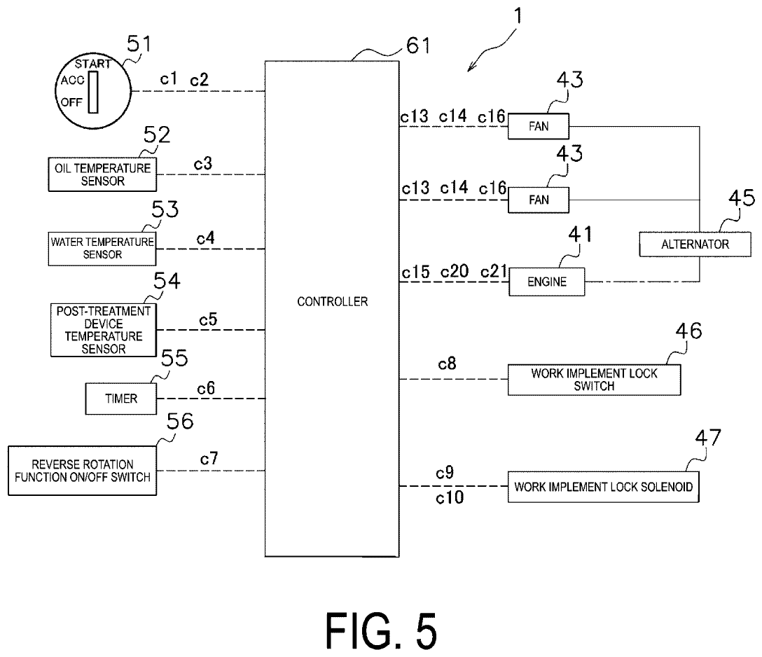

FIG. 5 is a block diagram illustrating a configuration related to control of the hydraulic excavator 1. In FIG. 5, the input and output of signals are indicated by dotted lines, the transmission of power is indicated by dot-dash lines, and the transmission of electric power is indicated by solid lines.

The hydraulic excavator 1 includes an alternator 45 (an example of a generator). The alternator 45 generates electric power using the power generated by the engine 41. The electric power generated by the alternator 45 is supplied to the fan 43. The fan 43 is driven by the electric power generated by the alternator 45. In the present embodiment, as illustrated in FIG. 2, two fans 43 are arranged side by side in the up-down direction. The fans 43 are disposed so that rotation axes thereof are parallel to the left-right direction.

When the fan 43 rotates in the forward direction, as indicated by the arrow A in FIG. 3, outside air is sucked in from the air port 32a and supplied into the engine room 32. The air sucked in from the air port 32a passes through the heat exchange unit 42, and when the air passes through the heat exchange unit 42, a fluid to be cooled is cooled in each heat exchanger. The air that has passed through the heat exchange unit 42 passes through the engine 41 and is discharged from the engine room 32 through the air port 32b.

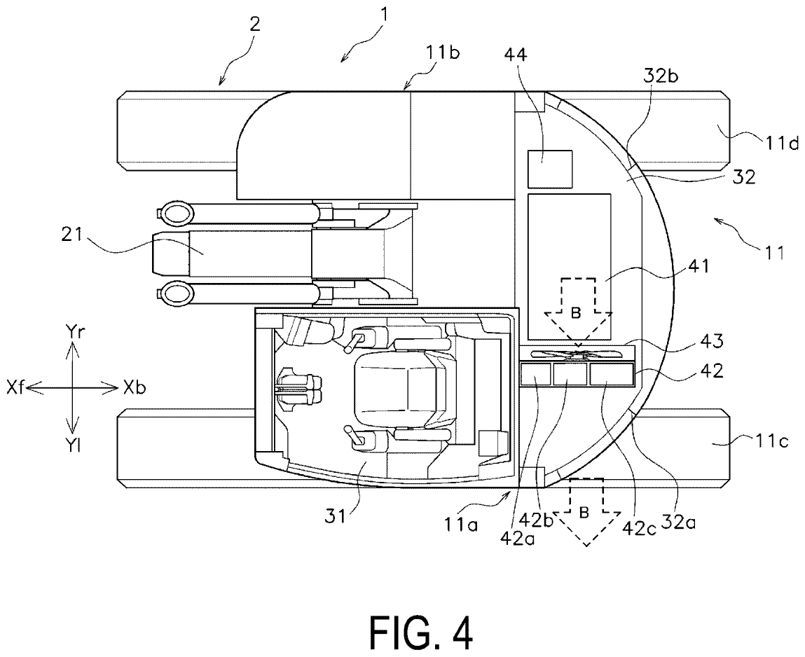

By such forward rotation of the fan 43, surrounding dust and the like adhere to a mesh of the air port 32a, and dust and the like that have passed through the air port 32a adhere to the heat exchange unit 42. In the present embodiment, in order to blow away the dust and the like adhering to the air port 32a and the heat exchange unit 42, the fan 43 is rotated in the reverse direction when the engine delay shutdown (EDS) is activated. The engine delay shutdown is a function of maintaining the engine 41 in a low idle state after the engine key is turned off until the post-treatment device 44 is cooled down, and then automatically turning off the engine 41. Here, the low idle state refers to a state in which the engine is operated at a low rotation speed lower than a normal rotation speed. By rotating the fan 43 in the reverse direction, the air port 32a and the heat exchange unit 42 are cleaned. In FIG. 4, the direction of air flow during reverse rotation is indicated by an arrow B.

When rotating in the reverse direction, all of the plurality of fans 43 may be rotated in the reverse direction at the same time, or each fan may be rotated in the reverse direction one by one in sequence at predetermined time intervals.

### Post-Treatment Device 44

The post-treatment device 44 treats exhaust gas from the engine 41. The post-treatment device 44 purifies the exhaust gas. For example, the post-treatment device 44 includes a urea selective catalytic reduction (SCR) system that uses a selective catalyst and a reducing agent to reduce and purify nitrogen oxides (NOx) contained in the exhaust gas. In the post-treatment device 44, urea water (DEF) as a reducing agent is injected into the exhaust gas upstream of the selective catalyst and vaporized and decomposed to produce ammonia and carbon dioxide. The produced ammonia is combined with a selective catalyst to convert nitrogen oxides into nitrogen and water. In this way, exhaust gas from the engine 41 is treated.

### Control Configuration of Hydraulic Excavator 1

Next, a configuration related to control of the hydraulic excavator 1 according to the present embodiment will be described.

As illustrated in FIG. 5, the hydraulic excavator 1 further includes an engine key 51 (an example of an operation unit), an oil temperature sensor 52, a water temperature sensor 53, a post-treatment device temperature sensor 54, a timer 55, a reverse rotation function on/off switch 56, and a controller 61.

The engine key 51 takes three positions by rotating a key: an engine START position, an ACC power ON position, and an engine OFF position. When a key is operated to the START position, the engine key 51 transmits a start signal c1 for the engine 41 to the controller 61. When a key is operated to the ACC position or the OFF position, a stop signal c2 for the engine is transmitted to the controller 61.

The oil temperature sensor 52 detects a temperature of the hydraulic oil passing through the oil cooler 42a, and outputs a detection signal c3 including information on the detected value to the controller 61. The oil temperature sensor 52 detects, for example, the temperature of the hydraulic oil at an inlet of the oil cooler 42a. Note that the present invention is not limited thereto, and the oil temperature sensor 52 may detect the temperature of the hydraulic oil at an outlet of the oil cooler 42a, or may detect the temperatures of the hydraulic oil at both the inlet and outlet.

The water temperature sensor 53 detects a temperature of the cooling water passing through the radiator 42c, and outputs a detection signal c4 including information on the detected value to the controller 61. The water temperature sensor 53 detects, for example, the temperature of the cooling water at an inlet of the radiator 42c. Note that the present invention is not limited thereto, and the water temperature sensor 53 may detect the temperature of the cooling water at an outlet of the radiator 42c, or may detect the temperatures of the cooling water at both the inlet and outlet.

The post-treatment device temperature sensor 54 detects an ambient temperature of the post-treatment device 44, and transmits a detection signal c5 including information on the detected value to the controller 61.

The timer 55 outputs a time signal c6 including time information to the controller 61. For example, the time signal c6 includes EDS time information from the start of EDS activation. The time signal c6 includes, for example, information on the reverse rotation time from the start of reverse rotation of the fan 43.

The reverse rotation function on/off switch 56 is operated by the operator for selecting whether or not to execute reverse rotation of the fan 43 during EDS. The reverse rotation function on/off switch 56 outputs a position signal c7 including the on or off position information of the switch to the controller 61.

The hydraulic excavator 1 further includes a work implement lock switch 46 and a work implement lock solenoid 47. The work implement lock switch 46 is used to lock the work implement 3. The work implement lock switch 46 is, for example, a lever. The work implement lock switch 46 is operated by the operator. When being operated by the operator, the work implement lock switch 46 outputs an operation signal c8 to the controller 61.

The work implement lock solenoid 47 operates a work implement lock valve to lock the driving of the work implement 3. The work implement lock valve can, for example, stop the supply of pilot oil for switching the position of the valve body of the valve that supplies hydraulic oil to the hydraulic cylinders 24, 25, and 26. By operating the work implement lock solenoid 47 and operating the work implement lock valve to cut off the pilot oil, the operation of the hydraulic cylinders 24, 25, and 26 is stopped and the driving of the work implement 3 is locked. When the controller 61 detects that the work implement lock switch 46 has been operated based on the operation signal c8, the controller 61 outputs an operation command signal c9 to the work implement lock solenoid 47. The work implement lock solenoid 47 switches between a locked state in which the work implement lock valve is operated and an unlocked state in which the work implement lock valve is not operated, based on the operation command signal c9 from the controller 61. The work implement lock solenoid 47 outputs a state signal c10 to the controller 61, which indicates whether the work implement lock solenoid 47 is in the locked state or the unlocked state.

The controller 61 includes a processor and a storage device. The processor is, for example, a central processing unit (CPU). Alternatively, the processor may be a processor different from the CPU. When the stop signal c2 is input, the processor activates the EDS in accordance with a program, based on the input signals c3 to c8, c10, and c12, and executes reverse rotation control to change the rotation of the fan 43 from forward rotation to reverse rotation.

The storage device includes a non-volatile memory such as a read only memory (ROM) and/or a volatile memory such as a random access memory (RAM). The storage device may include a hard disk or an auxiliary storage device such as a solid state drive (SSD). The storage device is an example of a non-transitory computer-readable recording medium. The storage device stores a first threshold value, a second threshold value, a third threshold value, an EDS maximum time, and a reverse rotation setting time related to reverse rotation control of the fan 43. The first threshold value is set for the temperature of the post-treatment device detected by the post-treatment device temperature sensor 54. The second threshold value is set for the temperature of the hydraulic oil detected by the oil temperature sensor 52. The third threshold value is set for the water temperature detected by the water temperature sensor 53. The EDS maximum time and the reverse rotation setting time are set for the time detected by the timer 55.

When the engine key 51 is operated to the START position and the start signal c1 is input, the controller 61 outputs a start command signal c20 to the engine 41. When the work implement lock switch 46 is operated and the operation signal c8 is input, the controller 61 outputs the operation command signal c9 to the work implement lock solenoid 47 to put the work implement 3 in the locked state. When the engine key 51 is operated to the ACC or OFF position and the stop signal c2 is input, the controller 61 executes EDS operation based on the signals c5, c6, and c10, and while the EDS is operating, executes reverse control to change the fan 43 from forward rotation to reverse rotation, based on the signals c3, c4, c6, and c7.

The controller 61 determines, based on the state signal c10 from the work implement lock solenoid 47, that the hydraulic excavator 1 is in a state in which the EDS can be activated, and activates the EDS when the controller 61 determines from the detection signal c5 that the temperature of the post-treatment device 44 is equal to or higher than the first threshold value.

The controller 61 determines whether or not the work implement lock solenoid 47 is activating, based on the state signal c10 from the work implement lock solenoid 47. When the controller 61 detects from the state signal c10 that the work implement lock solenoid 47 is activating, the controller 61 determines that the work implement 3 is in a locked state and therefore that the hydraulic excavator 1 is in a state in which the EDS can be activated. Note that the controller 61 may determine that the work implement 3 is in the locked state, based on the operation signal c8 from the work implement lock switch 46 instead of the state signal c10.

When the controller 61 determines from the detection signal c5 that the temperature of the post-treatment device 44 is equal to or higher than the first threshold value, the controller 61 activates the EDS because the temperature of the post-treatment device 44 is high and needs to be cooled. On the other hand, when the controller 61 determines that the temperature of the post-treatment device 44 is lower than the first threshold value, the controller 61 performs a normal shutdown without activating the EDS because the temperature of the post-treatment device 44 is not high. In a normal shutdown, the controller 61 outputs a stop command signal c13 to the fan 43 to stop the rotation of the fan 43, and outputs a stop command signal c15 to the engine 41 to stop the engine 41.

In a case where the controller 61 determines, based on the position signal c7 from the reverse rotation function on/off switch 56, that the reverse rotation function is on when the EDS is activated, the controller 61 outputs a reverse rotation command signal c14 to execute reverse rotation of the fan 43. On the other hand, in a case where the controller 61 determines, based on the position signal c7 from the reverse rotation function on/off switch 56, that the reverse rotation function is off when the EDS is activated, the controller 61 does not execute reverse rotation of the fan 43. The reverse rotation of the two fans 43 may be performed simultaneously, or may be performed one by one. In performing the reverse rotation one by one, it is preferable to rotate the fans 43 in the forward direction other than the fan 43 that is rotated in the reverse direction.

The controller 61 performs reverse rotation of the fan 43, based on the detection signal c3 from the oil temperature sensor 52 and the detection signal c4 from the water temperature sensor 53, when the temperature of the hydraulic oil is equal to or lower than a second threshold value and the water temperature is equal to or lower than a third threshold value. When the fan 43 rotates in the reverse direction, the cooling efficiency by the fan 43 decreases. Therefore, when the temperature of the hydraulic oil is greater than the second threshold value, the controller 61 does not execute reverse rotation of the fan 43 when the EDS is activated. Furthermore, when the water temperature is greater than the third threshold value, the controller 61 does not execute reverse rotation of the fan 43 when the EDS is activated.

When the operation time of the EDS reaches the EDS maximum time based on the time signal c6 from the timer 55, the controller 61 outputs the stop command signal c15 to the engine 41 and outputs the stop command signal c13 to the fan 43 to end the EDS operation.

When the time of reverse rotation of the fan 43 reaches the reverse rotation setting time, based on the time signal c6 from the timer 55, the controller 61 outputs a forward rotation command signal c16 to the fan 43 to rotate the fan 43 in the forward direction.

### Operation

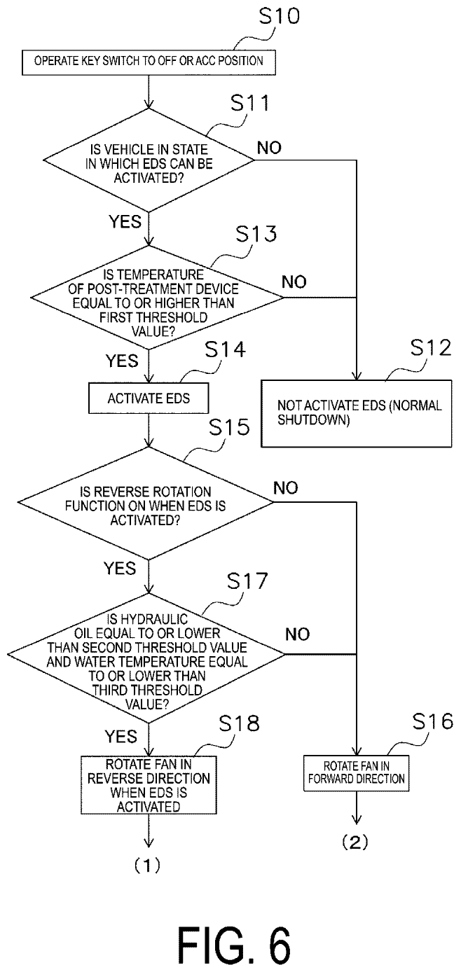

Next, the control operation of the hydraulic excavator 1 according to the present embodiment will be described. FIGS. 6, 7, and 8 are flowcharts illustrating the control operation of the hydraulic excavator 1 according to the present embodiment.

First, the operation at the start of EDS activation will be described.

In step S10, the controller 61 detects, based on the stop signal c2, that the engine key 51 has been operated to the OFF position or the ACC position.

Next, in step S11, the controller 61 determines, based on the state signal c10 from the work implement lock solenoid 47, whether or not the hydraulic excavator 1 is in a state in which the EDS can be activated. When the controller 61 detects that the work implement lock solenoid 47 is activating based on the state signal c10, the controller 61 determines that the hydraulic excavator 1 is in a state in which the EDS can be activated.

When it is determined in step S11 that the EDS is not in an activatable state, the controller 61 performs a normal shutdown in step S12 without activating the EDS. Specifically, the controller 61 outputs the stop command signal c13 to the fan 43 to stop the rotation of the fan 43, and outputs the stop command signal c15 to the engine 41 to stop the engine 41.

When it is determined in step S11 that the EDS is in an activatable state, in step S13, the controller 61 determines, based on the detection signal c5, whether or not the temperature of the post-treatment device 44 is equal to or higher than a first threshold value.

When it is determined in step S13 that the temperature of the post-treatment device 44 is lower than the first threshold value, there is no need to activate the EDS. Therefore, the control proceeds to step S12, and a normal shutdown is performed without activating the EDS.

When it is determined in step S13 that the temperature of the post-treatment device 44 is equal to or higher than the first threshold value, the controller 61 activates the EDS in step S14. Specifically, the controller 61 does not output the stop command signal c15 to the engine 41, and maintains the engine 41 in a low idle state.

Next, in step S15, the controller 61 determines, based on the position signal c7 from the reverse rotation function on/off switch 56, whether or not the reverse rotation function is on. When it is determined in step S15 that the reverse rotation function is off, in step S16, the controller 61 maintains the fan 43 in the forward rotation state.

On the other hand, when it is determined in step S15 that the reverse rotation function is on, in step S17, the controller 61 determines, based on the detection signal c3 from the oil temperature sensor 52 and the detection signal c4 from the water temperature sensor 53, whether or not the temperature of the hydraulic oil is equal to or lower than the second threshold value and the water temperature is equal to or lower than the third threshold value. When it is determined in step S17 that the temperature of the hydraulic oil is higher than the second threshold value or the water temperature is higher than the third threshold value, the control proceeds to step S16, and the controller 61 maintains the fan 43 in the forward rotation state.

On the other hand, when it is determined in step S17 that the temperature of the hydraulic oil is equal to or lower than the second threshold value and the water temperature is equal to or lower than the third threshold value, in step S18, the controller 61 outputs the reverse rotation command signal c14 to the fan 43 to rotate the fan 43 in the reverse direction.

Next, the operation at the end of EDS activation will be described.

When the fan 43 rotates in the reverse direction in step S18, the control proceeds to step S19.

In step S19, the controller 61 determines, based on the stop signal c2, whether the key position of the engine key 51 is in OFF or ACC. When it is determined that the key position is not in OFF or ACC, the key position is in START, and therefore, in step S20, the controller 61 ends the EDS activation. Specifically, the controller 61 outputs a return command c21 to return the engine 41 from the low idle state, and outputs the forward rotation command signal c16 to the fan 43 to return the fan 43 to forward rotation.

When it is determined in step S19 that the key position is in OFF or ACC, in step S21, the controller 61 determines, based on the state signal c10 from the work implement lock solenoid 47, whether or not the hydraulic excavator 1 is in a state in which the EDS can be activated. When it is determined in step S21 that the EDS is not in the activatable state, the controller 61 ends the EDS activation in step S22. Specifically, the controller 61 outputs the stop command signal c15 to the engine 41 to stop the engine 41, and outputs the stop command signal c13 to the fan 43 to stop the fan 43.

When it is determined in step S21 that the EDS is in an activatable state, in step S23, the controller 61 determines, based on the detection signal c5, whether or not the temperature of the post-treatment device 44 is equal to or higher than a first threshold value. When it is determined in step S23 that the temperature of the post-treatment device 44 is lower than the first threshold value, the control proceeds to step S22, and the EDS operation is ended.

When it is determined in step S23 that the temperature of the post-treatment device 44 is equal to or higher than the first threshold value, in step S24, the controller 61 determines, based on the time signal c6 from the timer 55, whether or not the operation time of the EDS has reached the EDS maximum time. When it is determined in step S24 that the operation time of the EDS has reached the EDS maximum time, the control proceeds to step S22, and the EDS activation is ended.

When it is determined in step S24 that the operation time of the EDS has not reached the EDS maximum time, the controller 61 continues the activation of the EDS in step S25.

Next, in step S26, the controller 61 determines whether or not the temperature of the hydraulic oil is equal to or lower than the second threshold value and the water temperature is equal to or lower than the third threshold value, based on the detection signal c3 from the oil temperature sensor 52 and the detection signal c4 from the water temperature sensor 53. When it is determined in step S26 that the temperature of the hydraulic oil is higher than the second threshold value or the water temperature is higher than the third threshold value, in order to increase the cooling efficiency, in step S27, the controller 61 outputs the forward rotation command signal c16 to the fan 43 to cause the fan 43 to return to forward rotation.

When it is determined in step S26 that the temperature of the hydraulic oil is equal to or lower than the second threshold value and the water temperature is equal to or lower than the third threshold value, in step S28, the controller 61 determines, based on the time signal c6 from the timer 55, whether or not the reverse rotation time of the fan 43 has reached the reverse rotation setting time. When it is determined in step S28 that the reverse rotation time of the fan 43 has reached the reverse rotation setting time, in step S27, the controller 61 rotates the fan 43 in the forward direction.

When it is determined in step S28 that the reverse rotation time of the fan 43 has not reached the reverse rotation setting time, in step S29, the controller 61 causes the fan 43 to continue rotating in the reverse direction. After step S29, the control proceeds to step S19.

On the other hand, when the fan 43 is rotated in the forward direction in steps S16 and S27, the control proceeds to step S30. In step S30, the controller 61 determines, based on the stop signal c2, whether the key position of the engine key 51 is in OFF or ACC. When it is determined that the key position is not in OFF or ACC, the key position is in START, and therefore, in step S31, the controller 61 ends the EDS activation. Specifically, the controller 61 outputs a return command c21 to the engine 41 to return the engine 41 from the low idle state and to cause the fan 43 to continue rotating in the forward direction.

When it is determined in step S30 that the key position is in OFF or ACC, in step S32, the controller 61 determines, based on the state signal c10 from the work implement lock switch 46, whether or not the hydraulic excavator 1 is in a state in which the EDS can be activated. When it is determined in step S32 that the EDS is not in an activatable state, the controller 61 ends the EDS activation in step S33. Specifically, the controller 61 outputs the stop command signal c15 to the engine 41 to stop the engine 41, and outputs the stop command signal c13 to the fan 43 to stop the fan 43.

When it is determined in step S32 that the EDS is in an activatable state, in step S34, the controller 61 determines, from the detection signal c5, whether or not the temperature of the post-treatment device 44 is equal to or higher than the first threshold value. When it is determined in step S34 that the temperature of the post-treatment device 44 is lower than the first threshold value, the control proceeds to step S33, and the EDS operation is ended.

When it is determined in step S34 that the temperature of the post-treatment device 44 is equal to or higher than the first threshold value, in step S35, the controller 61 determines, based on the time signal c6 from the timer 55, whether or not the activation time of the EDS has reached the EDS maximum time. When it is determined in step S35 that the activation time of the EDS has reached the EDS maximum time, the control proceeds to step S33, and the EDS activation is ended.

When it is determined in step S35 that the operation time of the EDS has not reached the EDS maximum time, the controller 61 continues the activation of the EDS in step S36.

Next, in step S37, the controller 61 determines whether or not the temperature of the hydraulic oil is equal to or lower than the second threshold value and the water temperature is equal to or lower than the third threshold value, based on the detection signal c3 from the oil temperature sensor 52 and the detection signal c4 from the water temperature sensor 53. When it is determined in step S37 that the temperature of the hydraulic oil is higher than the second threshold value or the water temperature is higher than the third threshold value, the controller 61 continues the forward rotation of the fan 43 in step S38. After step S38, the control proceeds to step S30.

When it is determined in step S37 that the temperature of the hydraulic oil is equal to or lower than the second threshold value and the water temperature is equal to or lower than the third threshold value, in step S39, the controller 61 outputs the reverse rotation command signal c14 to the fan 43 to rotate the fan 43 in the reverse direction. After step S39, the control proceeds to step S19.

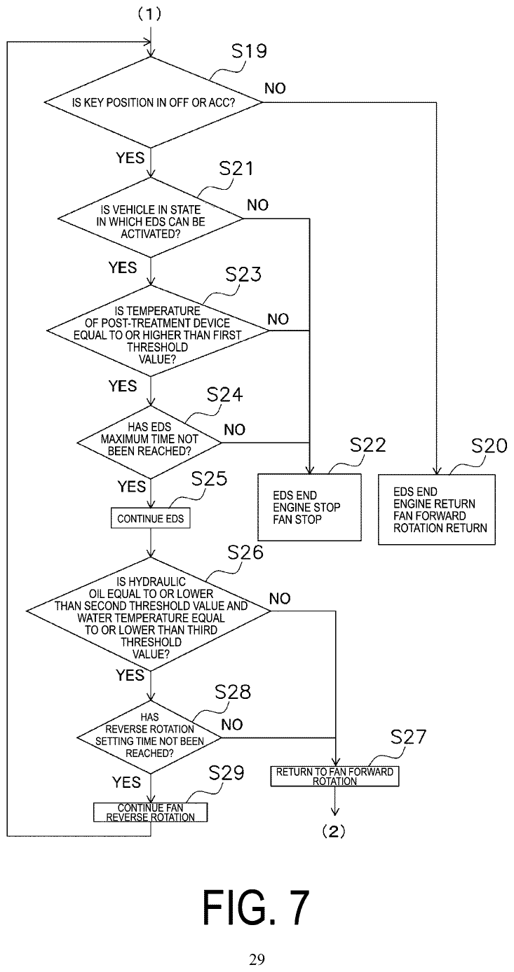

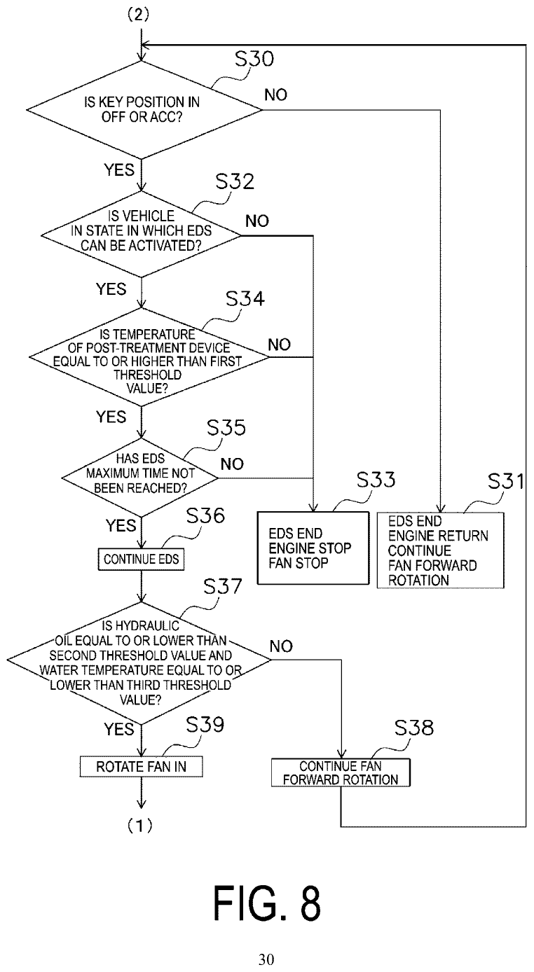

As described above, when the EDS is activated in step S14, the operations illustrated in FIGS. 7 and 8 are repeated in steps S20, S22, S31, and S33 until the EDS activation is ended. In addition, while the EDS operation continues, when the temperature of the hydraulic oil is equal to or lower than the second threshold value and the water temperature is equal to or lower than the third threshold value, the fan 43 is controlled to rotate in the reverse direction, and when the temperature of the hydraulic oil is higher than the second threshold value or the water temperature is higher than the third threshold value, the fan 43 is controlled to rotate in the forward direction.

### Features

(1)

The hydraulic excavator 1 according to the present embodiment includes the engine 41, the engine key 51 (an example of an operation unit), a heat exchanger, the fan 43, and the controller 61. The engine key 51 outputs the stop signal c2 for the engine 41. The fan 43 cools the heat exchanger. The controller 61 changes rotation of the fan 43 from forward rotation to reverse rotation during a period from when the stop signal c2 is input to when the engine 41 is stopped.

This ensures a time from when the stop signal c2 is input to when the engine 41 is stopped, and during this time, the fan 43 can be rotated in the reverse direction to perform cleaning. In this way, cleaning is performed automatically when the operation of the hydraulic excavator 1 ends and the engine 41 is stopped, so that the heat exchanger can be cleaned more reliably.
(2)

In the hydraulic excavator 1 according to the present embodiment, the controller 61 operates the engine 41 at a low rotation speed lower than a normal rotation speed during the period from when the stop signal c2 is input to when the engine 41 is stopped.

Accordingly, during the period from when the stop signal c2 is input to when the engine 41 is stopped, the engine 41 can be operated, for example, at low idle. When high-load work is being performed, the temperature of the hydraulic oil or the water temperature becomes high, and it may not be possible to perform the reverse rotation of the fan 43, which would reduce the cooling efficiency. However, after the stop signal c2 is input from the engine key 51, no work is being performed and the engine 41 is simply rotating at low idle in a state in which the vehicle is parked. Therefore, no load is applied, the temperature of the hydraulic oil or the water temperature does not become high, and thus the fan 43 can be rotated in the reverse direction more reliably.
(3)

The hydraulic excavator 1 according to the present embodiment further includes the alternator 45 that generates electricity by being driven by the engine 41. The fan 43 is an electric fan. The fan 43 is driven by electricity generated by the alternator 45.

In this way, the fan 43 is driven by the power generated by the generator while the engine is driving, so that the reduction in the battery charge caused by the driving of the fan 43 during EDS can be suppressed.
(4)

The hydraulic excavator 1 according to the present embodiment further includes the post-treatment device 44. The post-treatment device treats the exhaust gas from the engine 41. The controller 61 operates the engine 41 at a low rotation speed in order to cool the post-treatment device 44 during the period from when the stop signal c2 is input to when the engine 41 is stopped.

Accordingly, during the activation time of the EDS for cooling the post-treatment device 44 after the stop signal c2 is input from the engine key 51, the fan 43 can be rotated in the reverse direction to clean the heat exchanger.
(5)

The hydraulic excavator 1 according to the present embodiment further includes the vehicle body 2 that houses the fan 43, the heat exchanger, and the engine 41. When the fan 43 rotates in the forward direction, air sucked in from outside the vehicle body 2 passes through the heat exchanger, and when the fan 43 rotates in the reverse direction, air inside the vehicle body 2 passes through the heat exchanger and is discharged to the outside.

Accordingly, dust and the like that adhere to the heat exchanger when the fan 43 rotates in the forward direction can be blown away and cleaned by rotating the fan 43 in the reverse direction.
(6)

In the hydraulic excavator 1 according to the present embodiment, the heat exchanger is a radiator 42c that cools the cooling water for the engine 41. The hydraulic excavator 1 further includes the water temperature sensor 53 that detects the temperature of the cooling water for the engine 41. When the temperature of the cooling water is equal to or lower than a third threshold value, the controller 61 changes the rotation of the fan 43 from forward rotation to reverse rotation, and when the temperature of the cooling water is higher than the third threshold value, the controller 61 maintains the forward rotation of the fan 43.

Since the cooling efficiency decreases when the fan 43 is rotated in the reverse direction, when the temperature of the cooling water is higher than the third threshold value, cleaning by rotating the fan 43 in the reverse direction is not performed, and the fan 43 is maintained in the forward rotation. This allows priority to be given to lowering the temperature of the cooling water.
(7)

In the hydraulic excavator 1 according to the present embodiment, the heat exchanger is the oil cooler 42a that cools the hydraulic oil. The hydraulic excavator 1 further includes the oil temperature sensor 52 that detects the temperature of the hydraulic oil. When the temperature of the hydraulic oil is equal to or lower than a second threshold value, the controller 61 changes the rotation of the fan 43 from forward rotation to reverse rotation, and when the temperature of the hydraulic oil is higher than the second threshold value, the controller 61 maintains the rotation of the fan 43 in the forward rotation.

Since the cooling efficiency decreases when the fan 43 is rotated in the reverse direction, when the temperature of the hydraulic oil is higher than the second threshold value, cleaning by rotating the fan 43 in the reverse direction is not performed, and the fan 43 is maintained in the forward rotation. This allows priority to be given to lowering the temperature of the hydraulic oil.
(8)

The hydraulic excavator 1 according to the present embodiment further includes the post-treatment device temperature sensor 54 (an example of a temperature sensor) that detects the temperature of the post-treatment device 44. The controller 61 stops the engine 41 and the fan 43 when the temperature of the post-treatment device 44 is equal to or lower than a first threshold value (an example of a predetermined temperature) or when a predetermined time has elapsed since the stop signal c2 was input from the engine key 51.

Accordingly, when the temperature of the post-treatment device 44 becomes equal to or lower than the first threshold value, or when the EDS has been activated for a predetermined time, the activation of the EDS can be ended.
(9)

In the hydraulic excavator 1 according to the present embodiment, the vehicle body 2 includes the air port 32a through which air is sucked in or discharged by the fan 43. The air port 32a, the heat exchanger, the fan 43, and the engine 41 are arranged side by side in this order.

Accordingly, when the fan 43 rotates in the forward direction, outside air is taken into the engine room 32 through the air port 32a. The air taken into the engine room 32 passes through the heat exchanger and the engine 41 in this order. When the fan 43 rotates in the reverse direction, air is discharged from the inside of the vehicle body 2 through the heat exchanger and from the air port 32a. Accordingly, dust and the like adhering to the air port 32a and the heat exchanger can be blown away.
(10)

The control method for the hydraulic excavator 1 according to the present embodiment includes step S10 (an example of a stop signal input step) and step S18 (an example of a rotation change step). In step S10, the stop signal c2 for stopping the engine 41 is input. In step S18, rotation of the fan for cooling the heat exchanger is changed from forward rotation to reverse rotation during a period from when the stop signal c2 is input to when the engine 41 is stopped.

This ensures a time from when the stop signal c2 is input from the engine key 51 to when the engine 41 is stopped, and during this time, the fan 43 can be rotated in the reverse direction to perform cleaning. In this way, cleaning is performed automatically when the operation of the hydraulic excavator 1 ends and the engine 41 is stopped, so that the heat exchanger can be cleaned more reliably.

### Other Embodiments

Although one embodiment of the present invention has been described above, the present invention is not limited to the above embodiment, and various modifications are possible without departing from the gist of the invention.
(A)

In the above embodiment, as illustrated in FIG. 2, the two fans 43 are arranged side by side in the up-down direction, but the number and arrangement of the fans 43 may not be limited to the configuration illustrated in the drawing. The number of fans 43 may be one or three or more. Furthermore, the fans 43 are not necessarily arranged in the vertical direction, but may be arranged side by side in the front-rear direction of the vehicle.
(B)

In the above embodiment, the temperature of the cooling water in the radiator 42c and the temperature of the hydraulic oil in the oil cooler 42a are detected to detect whether or not the temperatures are equal to or higher than a predetermined threshold value, but the present invention is not limited thereto. For example, a temperature sensor may be provided to detect the temperature of the air passing through the aftercooler 42b, and when the air temperature is equal to or lower than a predetermined threshold value, the fan 43 may be controlled to rotate in the reverse direction, and when the air temperature is higher than the predetermined threshold value, the fan 43 may be controlled not to rotate in the reverse direction.
(C)

The hydraulic excavator 1 according to the above embodiment may be provided with a temperature sensor that detects the temperature of the engine oil disposed at an oil pan of the engine 41. In this case, when the temperature of the engine oil is equal to or lower than a predetermined threshold value, the fan 43 may be controlled to rotate in the reverse direction, and when the temperature of the engine oil is higher than the predetermined threshold value, the fan 43 may be controlled not to rotate in the reverse direction.
(D)

In the above embodiment, a hydraulic excavator has been used as an example of a work machine, but the present invention may not be limited thereto, and a bulldozer, a wheel loader, a dump truck, a forklift, or the like may be used.

### INDUSTRIAL APPLICABILITY

The present disclosure has an effect of enabling more reliable cleaning of a heat exchanger, and is useful for work machines and the like.

1. A work machine comprising:
an engine;
an operation unit configured to output a stop signal for the engine;
a heat exchanger;
a fan configured to cool the heat exchanger; and
a controller configured to change rotation of the fan from forward rotation to reverse rotation during a period from when the stop signal is input to when the engine is stopped.

2. The work machine according to claim 1, wherein
the controller is configured to operate the engine at a low rotation speed slower than a normal rotation speed during the period from when the stop signal is input to when the engine is stopped.

3. The work machine according to claim 1, further comprising:
a generator configured to generate electricity by driving the engine,
the fan being an electric fan, and
the electric fan being driven by using electricity generated by the generator.

4. The work machine according to claim 2, further comprising:
a post-treatment device configured to treat exhaust gas from the engine,
the controller being configured to cause the engine to operate at the low rotation speed to cool the post-treatment device during the period from when the stop signal is input to when the engine is stopped.

5. The work machine according to claim 1, further comprising:
a vehicle body configured to house the fan, the heat exchanger, and the engine,
when the fan rotates in a forward direction, air sucked in from outside the vehicle body passing through the heat exchanger, and
when the fan rotates in a reverse direction, air inside the vehicle body passing through the heat exchanger and being discharged to the outside.

6. The work machine according to claim 1, wherein
the heat exchanger is a radiator configured to cool cooling water for the engine,
the work machine further comprises a water temperature sensor configured to detect a temperature of the cooling water, and
the controller is configured to
change the rotation of the fan from forward rotation to reverse rotation when the temperature of the cooling water is equal to or lower than a predetermined temperature, and
maintain the rotation of the fan in forward rotation when the temperature of the cooling water is higher than the predetermined temperature.

7. The work machine according to claim 1, wherein
the heat exchanger is an oil cooler configured to cool hydraulic oil,
the work machine further comprises an oil temperature sensor configured to detect a temperature of the hydraulic oil, and
the controller is configured to
change the rotation of the fan from forward rotation to reverse rotation when the temperature of the hydraulic oil is equal to or higher than a predetermined temperature, and
maintain the rotation of the fan in forward rotation when the temperature of the hydraulic oil is higher than the predetermined temperature.

8. The work machine according to claim 4, further comprising:
a temperature sensor configured to detect a temperature of the post-treatment device,
the controller being configured to stop the engine and the fan
when the temperature of the post-treatment device is equal to or lower than a predetermined temperature, or
when a predetermined time has elapsed since the stop signal was input from the operation unit.

9. The work machine according to claim 5, wherein
the vehicle body includes an air port through which air is sucked in or discharged by the fan, and
the air port, the heat exchanger, the fan, and the engine are arranged side by side in order of the air port, the heat exchanger, the fan, and the engine.

10. A control method for a work machine, the control method comprising:
inputting a stop signal in order to stop an engine; and
changing rotation of a fan that cools a heat exchanger from forward rotation to reverse rotation during a period from when the stop signal is input to when the engine is stopped.
